(19) United States
(12) Patent Application Publication
(10) Pub. No.: US 2011/0248678 A1
(43) Pub. Date: Oct. 13, 2011

(54) INTELLIGENT BATTERY MANAGEMENT SYSTEM AND METHOD

(75) Inventors: John M. Wade, Ramona, CA (US); Shalom Arie Lev, San Diego, CA (US)

(73) Assignee: GRRREEN, Inc., a Delaware corporation, Solana Beach, CA (US)

(21) Appl. No.: 13/075,145

(22) Filed: Mar. 29, 2011

Related U.S. Application Data
(60) Provisional application No. 61/323,835, filed on Apr. 13, 2010.

(51) Int. Cl. H02J 7/04

(52) U.S. Cl. 320/119

(57) ABSTRACT

A method and apparatus for the intelligent management of multi-cell battery pack. A battery management system which may be mounted on board a vehicle facilitates battery management including monitoring the state of charge of the battery pack. Wireless communication equipment facilitate communication between the battery management system to a remote location. A battery charger controlled by the battery management system charges individual cells of the battery pack.

### RELATED PATENT APPLICATIONS

This present non-provisional patent application hereby claims priority to U.S. provisional patent application No. 61/323,835, filed Apr. 13, 2010, for INTELLIGENT BATTERY MANAGEMENT SYSTEM AND METHOD, which is incorporated herein by reference.

This present non-provisional patent application hereby incorporates by reference U.S. patent application No. (20679-103), filed Mar. 29, 2011, entitled BATTERY CHARGING SYSTEM AND METHOD; U.S. patent application No. (20679-105), filed Mar. 29, 2011, entitled INDIVIDUAL CELL CHARGER AND METHOD OF USING SAME; and U.S. patent application Ser. No. 12/650,401 filed Dec. 30, 2009, entitled SYSTEMS AND METHODS FOR MANAGING CHARGE AND DISCHARGE FOR BATTERIES.

### FIELD OF THE INVENTION

The present invention relates in general to a system and method for managing the charging and discharging functions of multiple-cell batteries. It more particularly relates to an intelligent system and method for managing the charging and discharging functions of multiple-cell batteries, while collecting and analyzing cell performance data to optimize or at least improve battery operation and to permit the monitoring of such cell performance data within fleets or groups of battery-powered vehicles, mobile equipment, and others.

### BACKGROUND OF THE INVENTION

This section includes descriptions of background art in the field of disclosed embodiments of the present invention. There is no intention, either express or implied, that any background art discussed in this section legally constitutes prior art.

There have been a variety of battery management systems. For example, reference may be made to U.S. Pat. No. 6,005,367, which is incorporated herein by reference.

Recent improvements in storage batteries, especially in Lithium Ion (Li Ion) technology, have given rise to more widespread use of batteries to power mobile equipment and vehicles that have been traditionally powered by internal combustion engines. While battery power is often preferred due to environmental considerations, it also provides other advantages such as reliability, safety and quiet operation.

Li Ion cells typically display terminal voltages in the range of 3 to 4 volts, which is not high enough to power typical drive motors. This limitation can be overcome by connecting Li Ion cells in series, so their voltages add up until an appropriate pack voltage is achieved to power the particular application.

To achieve a desired battery lifetime, battery manufacturers specify the operating parameters for cells in terms of the maximum voltage during charge, and the minimum voltage during discharge. Batteries must be charged and discharged within these parameters, to deliver an expected number of charge/discharge cycles during their lifetime. In order to control and manage battery charging and discharging within the specified parameters, most applications require use of a Battery Management System (BMS). The BMS typically monitors the individual cells and is able to control both the charge and discharge functions to insure that the cells are charged and discharged in accordance with their specifications.

The cells need to be balanced in both energy capacity and charge in order to deliver their optimum performance. For example, if an individual cell within in a battery pack of cells connected in series is under-charged relative to other cells within the pack, the under-charged cell will discharge to its minimum voltage before the other cells. In this case the BMS will shut down the discharge process, even though useable charge remains in the other cells.

The same is true if an individual cell has a lower capacity than the other cells in a pack: even though all cells are fully charged at the start, the low capacity cell may discharge first and the BMS will shut down the discharge process, even though the other cells may contain useable charge. Recent improvements in BMS/charger technology such as, for example, the BMS technology described in U.S. patent application Ser. Nos. 12/650,401, filed Dec. 30, 2009 and 61/319,187, filed Mar. 30, 2010, are each incorporated herein by reference, and have enabled a BMS to provide that all cells are fully charged prior to use. However, capacity matching remains an important consideration.

Since cell capacity is subject to degradation over time and usage, it is important to monitor cell performance to assure proper operation is being achieved, even if cells are initially matched. Monitoring cell performance involves the collection and analysis of large amounts of data, and can be quite laborious if done manually. This is especially true when the number of battery-powered vehicles or pieces of equipment is large, such as, for example, a fleet of golf carts, or warehouse material handling trucks. Particularly in such cases, it would be useful to facilitate the data collection and analysis by providing a BMS with “intelligence.” Therefore, due to the nature of batteries made up of multiple Li Ion cells, and the advantages of powering large numbers of vehicles or equipment powered by such batteries, a need exists for a system that can provide this functionality in a more efficient and effective manner.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1. is a schematic diagram of an intelligent battery charging system, which is constructed in accordance with an embodiment of the present invention.

### CERTAIN EMBODIMENTS OF THE INVENTION

It will be readily understood that the components of the embodiments, as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of embodiments of the invention.

In accordance with at least one embodiment of the present invention, there are provided a system and method for the automated collection and analysis of performance data of individual battery cells, connected in series, within battery packs. Such automated data collection and analysis functions, as well as other functions described below, may be particularly useful in the management of fleets of electric vehicles or other mobile equipment. In this regard, each vehicle or mobile equipment would have a battery management system on board and be able to communicate wirelessly to a central stationary remote user access. A portable computer and/or a local display/keypad enables the vehicle operator to obtain data as well.

In an embodiment of the present invention, the BMS may perform normal battery management functions such as controlling a battery charger either locally or remotely to prevent individual cells from exceeding a maximum voltage specification during charging. In another aspect of an embodiment of the present invention, the BMS may operate a load controller to prevent individual cells from being drained to a voltage lower than a minimum voltage specification, or from exceeding a maximum temperature specification. The BMS may perform such functions by sampling individual cell voltages and temperatures at predetermined intervals. For example, in an aspect of the invention, the BMS can sample individual cell parameters such as cell voltage and temperature at least 100 times per second. By averaging at least 10 such readings, and comparing this average with the cell specifications, the BMS may generate a signal to limit charging or loading. If BMS sampling of cell parameters indicates that any cell parameter deviates from respective cell specifications, the BMS may record such event data in a memory storage medium with a time stamp.

In another embodiment of the invention, the BMS may include a wireless, satellite-based, or local communication medium that is known in the art, to facilitate the collection of battery cell data from battery-powered mobile equipment or vehicles and uploading of such data to a central or remote data storage facility. A BMS configured with such a wireless, satellite-based, or local communication medium can also facilitate the transmission of instructions to the equipment or vehicle. The communication medium may take the form of cell phone data transmission, WiFi connectivity, communication via satellite link, or other, depending on particular needs. For example, it may be particularly advantageous to communicate with equipment that is housed, stored, or otherwise grouped together in a central charging area, using WiFi technology, since the communication distances are relatively short between a WiFi hotspot and a vehicle or piece of mobile equipment being charged in such a central area. Alternatively, cellular network technology may more advantageously facilitate communication with electric delivery trucks in an urban area that are charged singly at geographically dispersed charging stations.

The state of charge of Li Ion cells may be determined by measuring their internal impedance and temperature. The BMS is capable of gathering and compiling this data in real time (as individual cells are being drained in use), by measuring the load current and cell voltage concurrently with temperature, and comparing successive measurements at different current draws, at close enough intervals that the temperature is not substantially different. The cell resistance may then be calculated by the equation R=(V2−V1)/(I2−I1). The BMS may determine the state of charge of a particular cell by averaging a number of readings and finding the charge value in a look-up table entry for the corresponding temperature. Such a table may be predetermined by characterization tests of the type of cells in use. During this process the data sample rates may also be increased to capture the transients that occur during loading. For example, the sample rates may be set to at least one reading per millisecond to do so. Calculation results may be averaged and displayed to the operator with 10 second updates and may be stored locally, with a periodic time stamp, for example, every minute during discharge. The data storage medium may be integrated with the powered device. For example, it may be located onboard the vehicle or other mobile equipment. Thus, the state of charge calculation may be used by the BMS to estimate the remaining usable energy in the pack, and the information can be presented to the operator. It is noted that for this calculation the weakest cell information is the determining factor.

As discussed above, in an embodiment of the invention, the BMS may incorporate data collection, storage and retrieval capability. Charging data, cell voltage, temperature, state of charge and certain other data may be stored locally with time/date stamps. Such locally-stored data may be compiled and periodically sent through a wireless, satellite-based, or local communications medium to a remote data server, by the BMS, where the data can be accessed at any time. The remote data server may be connected to the Internet, and configured for communication via the Internet. In an embodiment of the invention, the data may also be accessible by wireless or satellite link, or locally by an operator or service technician. In another embodiment of the invention, the BMS may allow data to be collected “on demand” through the same communication means. This may allow fleet managers or others to access data revealing charging, usage and maintenance patterns, and the current health of the battery systems in a fleet of vehicles or other mobile equipment.

In managing such a fleet of battery-powered vehicles, gathering and providing access to GPS information can be advantageous. In various scenarios, it may be important for a manager to know individual fleet vehicles or equipment are located. For example, if a battery or other problem arises in the field, it may be important to know the location of the equipment or vehicle so it can be serviced or retrieved. Also, it may be important for the manager to know if a vehicle or equipment has been taken outside of a pre-determined area boundary. Accordingly, in another embodiment of the invention, the BMS is capable of acquiring GPS data, and sending an immediate message, via wireless, satellite-based, or local communications medium, noting such events at the time that they happen, as well as noting and storing routine location information periodically for later retrieval and analysis. In an embodiment of the invention providing for two-way wireless or satellite-based communication with a vehicle or piece of equipment, a manager may also send a location query at any time and receive an immediate response.

Remote control functionality incorporated into another embodiment of the invention is another feature that is advantageous in managing a fleet. Particularly in an electric vehicle application, the need may arise to immobilize the vehicle, or terminate travel by remote means, for example, in a security breach situation, or if it becomes known to a manager that equipment is being used in an improper way. In these cases it may be necessary for an authorized person or manager to over ride the commands of an operator. Integrating wireless, satellite-based, or local communications capability into the BMS is a mode of enabling this remote control functionality whereby the BMS can carry out the steps to disable or immobilize a vehicle or piece of equipment.

Another embodiment of the present invention may include functionality to provide maintenance reminders for a device powered by batteries managed by the BMS. Such reminders may take the form of an onboard message to the operator, a message transmitted to a manager, or an entry in a data log on a server connected to the internet. The BMS may generate such maintenance reminders based on a predetermined maintenance plan, and a comparison with stored usage data. The communication of maintenance information to and from the powered device may occur via wireless, satellite, or local communication modes.

It is advantageous for battery charging to occur during economical windows of time. It is generally known that an electrical power supply grid has periods of low usage and that power companies often encourage “off peak” consumption by offering reduced rates during such periods. In another embodiment of the invention, the BMS may be configured with a real time clock, and the BMS may be programmed to control the charger in a way that charging only occurs during “off peak” periods, to obtain the greatest economy.

It may also be advantageous to require authorization to operate a device powered by batteries controlled by a BMS according to the present invention. In another embodiment of the invention, the BMS may have the capability to require an operator to enter an authorization code before the powered equipment can be operated. The code may be set and changed either locally or remotely by an individual using a system management code. Such operation and transmittal of data may occur via wireless, satellite, or local communication modes that are known in the art.

Another embodiment of the present invention may include a BMS with the capability to receive firmware upgrades through wireless, satellite, or local communication mediums.

It is advantageous to limit BMS power consumption, to avoid draining the battery when the vehicle or equipment is not in use, and the BMS is not active. In another embodiment of the invention, the BMS may be configured to enter a “sleep” mode which consumes very low power. A BMS according to an embodiment of the present invention may also have a low power “wake-up” sensor that “wakes-up” the BMS (i.e., returns the BMS to a “non-sleep” mode) when certain events take place:

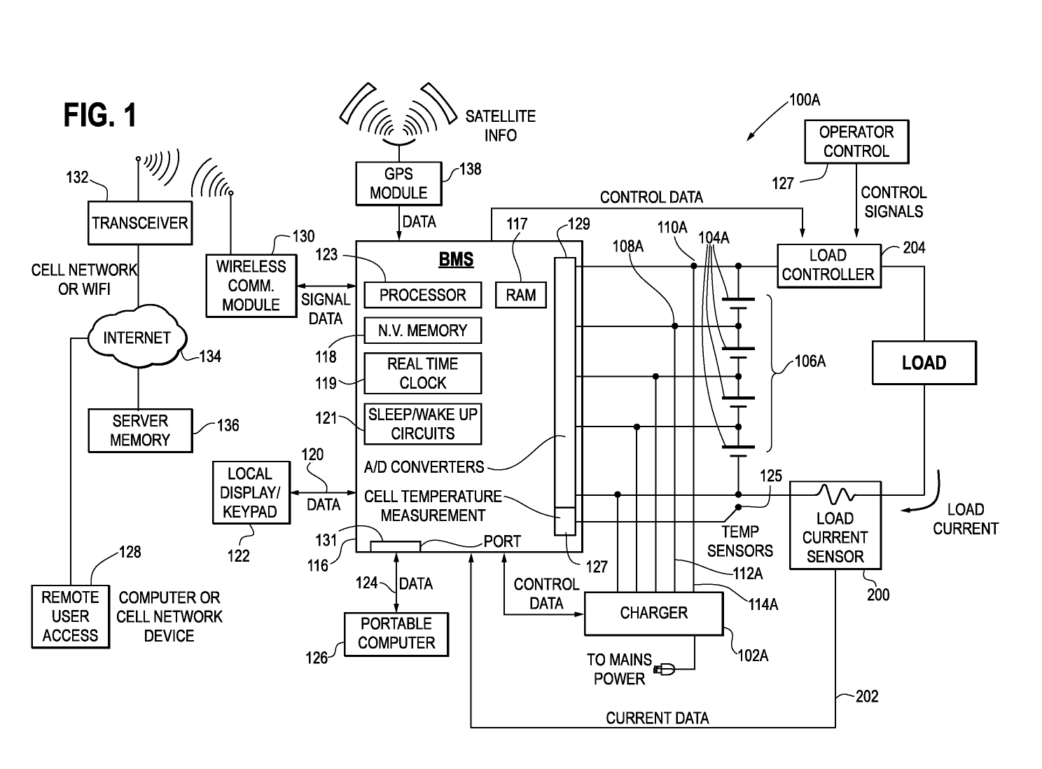

Referring to FIG. 1, there is shown a schematic view of an “intelligent” BMS system 100A according to an embodiment of the present invention, with elements capable of performing functions described above. The system 100A illustrated in FIG. 1 provides a battery cell charger 102A, connected to individual battery cells 104A connected in series, in a string forming a battery pack, shown generally at 106A. In order to charge each cell 104A, the charger 102A is connected to cell terminals of each cell 104A, such as terminals 108A and 110A, through a pair of connections, such as connections 112A and 114A. Also shown is a BMS 116 that, among other functions, has analog to digital converters 129 that monitor the state of charge of the battery pack 106A, and the individual cells 104A. The system 100A may be configured for use with various types of battery powered devices, such as mounted onboard vehicles and mobile equipment, among others. The device (not shown) powered by the battery pack, 106A, whether a vehicle, or item of mobile equipment, or other battery-powered device, is represented by a load 204 on the battery pack 106A. It is to be understood that the embodiments of the present invention, whether or not disclosed herein, may or may not relate to charging batteries used in vehicles, as there are a variety of other applications which are also contemplated.

In various aspects of the invention, the BMS 116 may be configured to include data storage media such as random-access memory 117, non-volatile memory 118, a real-time clock 119, and sleep/wake-up circuitry 121. In another aspect of the invention, a processor 123 of the BMS 116 may receive inputs from sensors such as sensor 125 and supplies it to a cell temperature measurement unit 127 that measure the temperature, voltage, and current of individual cells 106A. In keeping with the spirit of the embodiments of the invention, such data may be communicated to the BMS 116 through various types of wired or wireless data connections. In one embodiment of the invention, load current sensor 200 transmits current data to the BMS 116 via data connection or lead 202.

In another embodiment of the invention, the BMS 116 provides control data to a load controller 204 in order to prevent individual cells from being drained to a voltage lower than a minimum voltage specification, or from exceeding a maximum temperature specification. In an embodiment of the invention, an operator control 127 for an operator of the device or equipment powered by the battery pack 106A may receive messages from the BMS processor 123 regarding the state of charge, or other parameters of the cells 102A or battery pack 106A. Based on the content of the message, an operator may issue control signals to the load controller 204 to prevent individual cells 104A from being drained to a voltage lower than a minimum voltage specification, to prevent individual cells 104A from exceeding a maximum temperature specification, or for other purposes.

In another embodiment of the invention, the BMS 116 may incorporate a port or other connection 120 to provide for local communication and data transfer between BMS 116 and an input/output device 122 such as a local display keypad. A user or operator such as a person on board a vehicle (not shown) powered at least in part by the battery pack 106A, can thus view and download data collected and stored by the BMS 116. The user or operator can also issue commands or upload other programming, instructions or firmware to the BMS 116. Another embodiment of the invention may include a port or other connection 124, to facilitate this type of two-way communication and data transfer between the BMS 116 and a portable computer 126.

In yet another embodiment of the invention, the BMS 116 may be connected to a wireless communication medium, for two-way communication with a remote user access point 128, where a remote user, operator, administrator or manager may view and download data collected and stored by the BMS 116, and issue commands or upload other programming, instructions or firmware to the BMS 116. To facilitate such communication, the BMS may be connected to a wireless communication module 130, which communicates with a wireless transceiver 132 via a wireless communication protocol which may be known in the art, such as, for example, WiFi, WiMax, Bluetooth, or a satellite communication connection protocol. The transceiver 132 may be connected to the remote use access point 128 via the Internet 134. In an embodiment of the invention, the Internet can also facilitate data transfer to a storage medium on a remote server 136.

In another embodiment of the invention, a GPS module 138 may be connected to the BMS 116. The GPS module 138 may provide location data to the BMS 116, and may also be configured to wirelessly transmit the location of a vehicle or other piece of mobile equipment in which the BMS 116 may be installed. In certain embodiments of the invention, such wireless transmittal of location data may be facilitated by satellite link, or via a wireless communication module 130, which is attached to the BMS 116, and is described in greater detail, above.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented.

1. An intelligent battery management system for mounting on board mobile equipment, comprising:
central stationary remote user access;
a battery pack having a series of cells mounted on mobile equipment for helping propel the equipment along the ground;
mobile battery management system mounted on board mobile equipment for facilitating battery management including, monitoring the state of charge of the battery pack;
wireless communication equipment for facilitating communication between the mobile battery management system and the central stationary remote user access;
a battery charger controlled by the battery management system for charging individual cells of the battery pack;
at least one sensor for monitoring load current from the battery pack and for supplying current data to the battery management system;
a load controller for facilitating load current in response to the battery management system; and
wherein the wireless communication equipment communicates the condition of the battery pack and the management of it to the remote user access.

2. The system according to claim 1, further including the battery management system including converters for monitoring individual cells of the battery pack.

3. The system according to claim 2, further including a temperature sensor for monitoring the temperature of the cells, and a cell temperature measurement unit responsive to the temperature sensor for measuring the temperature, voltage or current of individual cells.

4. The system according to claim 3, further including an operator control for an operator of the mobile equipment for receiving messages from the battery management system regarding the state of parameters of the cells.

5. The system according to claim 4, further including a part of the battery management system for supplying data, and a local display/keypad unit for receiving the data.

6. The system according to claim 4, further including a portable computer part of the battery management system.

7. The system according to claim 4, wherein the wireless communication equipment includes a wireless communication module for downloading data collected and stored by the battery management system.

8. An intelligent battery management system, comprising:
a battery pack having a series of cells;
a battery management system for facilitating battery management including monitoring the state of charge of the battery pack;
wireless communication equipment for facilitating communication between the battery management system to a remote location; and
a battery charger controlled by the battery management system for charging individual cells of the battery pack.

9. The system according to claim 8, wherein the battery management system includes converters for monitoring individual cells of the battery pack.

10. The system according to claim 9, further including a temperature sensor for monitoring the temperature of the cells, and a cell temperature measurement unit responsive to the temperature sensor for measuring the temperature, voltage or current of individual cells.

11. The system according to claim 10, further including an operator control for use by an operator of the mobile equipment for receiving messages from the battery management system regarding the state of parameters of the cells.

12. The system according to claim 11, further including a part of the battery management system for supplying data, and a local display/keypad unit for receiving the data.

13. The system according to claim 11, further including a portable computer part of the battery management system.

14. The system according to claim 11, wherein the wireless communication equipment includes a wireless communication module for downloading data collected and stored by the battery management system.

15. A method of managing batteries employed on a number of vehicles, comprising: facilitating wireless communication between mobile battery management systems and a central stationary remote user access; using the remote user access to receive and send battery performance data.

16. A method according to claim 15, further including controlling, using the battery management system, either locally or remotely, a battery charger to prevent individual cells from exceeding a maximum voltage specification during charging.
